(19) United States
(12) Patent Application Publication
(10) Pub. No.: US 2006/0234522 A1
(43) Pub. Date: Oct. 19, 2006

(54) Button module and electronic device using the same

(75) Inventors: Gwo-Ching Lin, Miao-Li (TW); Chi-Chang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/403,679

(22) Filed: Apr. 13, 2006

(30) Foreign Application Priority Data
Apr. 15, 2005 (TW) 94205941

(51) Int. Cl. H01R 12/00

(52) U.S. Cl. 439/66

(57) ABSTRACT

A button module (2) includes a touch pad (21), a printed circuit board (23) and at least one elastic contact pad (22) sandwiched between the touch pad and the printed circuit board. An electronic device includes a frame having at least one protrusion (261) and the button module. The touch pad includes at least one first locking hole (217) and the printed circuit board includes at least one second locking hole (237). The at least one first and second locking holes are corresponding to each other in location, and the at least one protrusion is engaged in the at least one first and second locking holes. The configuration of the protrusions and the first and second locking holes may cooperatively fasten the button module avoiding using bolts and can decrease a thickness.

### FIELD OF THE INVENTION

The present invention relates to a button module, and electronic devices such as display devices and the like which use button modules.

### GENERAL BACKGROUND

In general, electronic devices such as display devices need a button module to control function menus, such as a menu of an on screen display (OSD).

As shown in FIG. 4, a typical button module 1 includes a positioning plate 11, and a plurality of touching buttons 12 arranged on the positioning plate 11. The touching buttons 12 electrically connect with a printed circuit board (PCB) 13 that is below the positioning plate 11. The positioning plate 11 is fastened on the printed circuit board 13 by a plurality of bolts 15. When the button module 1 is used in a product such as a display device or display unit, it may drive displaying function menus via pressing of the touching buttons 12.

With this structure, the touching buttons 12 and the screws 15 add to an overall thickness of the electronic device employing the button module 1. Moreover, the need for the screws 15 adds to costs and the time needed to assemble the button module 1.

What is needed, therefore, is a button module that overcomes the above-described deficiencies.

### SUMMARY

A button module includes a touch pad, a printed circuit board and at least one elastic contact pad sandwiched between the touch pad and the printed circuit board.

An electronic device includes a frame having at least one protrusion and a button module. The button module includes a touch pad having at least one first locking hole, a printed circuit board having at least one second locking hole, at least one elastic contact pad sandwiched between the touch pad and the printed circuit board. The at least one first and second locking holes are corresponding to each other in location, and the at least one protrusion is engaged in the at least one first and second locking holes.

The configuration of the protrusions and the first and second locking holes may cooperatively fasten the button module avoiding using bolts and can decrease a thickness.

Other advantages and novel features will become more apparent from the following detailed description when taken in conjunction with the accompanying drawings.

### BRIEF DESCRIPTION OF THE DRAWINGS

FIG. 1 is a schematic, exploded, isometric view of a button module according to an exemplary embodiment of the present invention.

FIG. 2 is a schematic, isometric view of the button module of FIG. 1 pre-assembled and ready to be removably mounted on a positioning tool, with contact pads of the button module being shown in phantom.

FIG. 3 is schematic, isometric view of the button module of FIG. 1 fully assembled and mounted to a display module, with the contact pads of the button module a part of the display module being shown in phantom.

FIG. 4 is a schematic, isometric view of a conventional button module.

### DETAILED DESCRIPTION OF PREFERRED EMBODIMENTS

FIG. 1 is a schematic, exploded, isometric view of a button module according to an exemplary embodiment of the present invention. The button module 2 includes a touch pad 21, a plurality of elastic contact pads 22, and a printed circuit board 23.

The touch pad 21 includes a pair of first positioning holes 210 and a pair of first locking holes 217. In the illustrated embodiment, the first locking holes 217 are slot-shaped. A material of the touch pad 21 may be polyethylene terephthalate (PET), polymethyl methacrylate (PMMA), or acrylonitrile butadiene styrene (ABS).

The elastic contact pads 22 are arranged on the printed circuit board 23 and electrically connect to the printed circuit board 23.

The elastic contact pads 22 are generally hemispherical, partially hemispherical, or ellipsoidal shaped, and are flexible. In particular, the elastic contact pads 22 can distort when an external force is applied, and resile when the external force is removed. In the illustrated embodiment, the elastic contact pads 22 are partially hemispherical.

The printed circuit board 23 includes a pair of second positioning holes 230 and a pair of second locking holes 237, respectively corresponding to the first positioning holes 210 and the first locking holes 217. In the illustrated embodiment, the second locking holes 237 are slot-shaped.

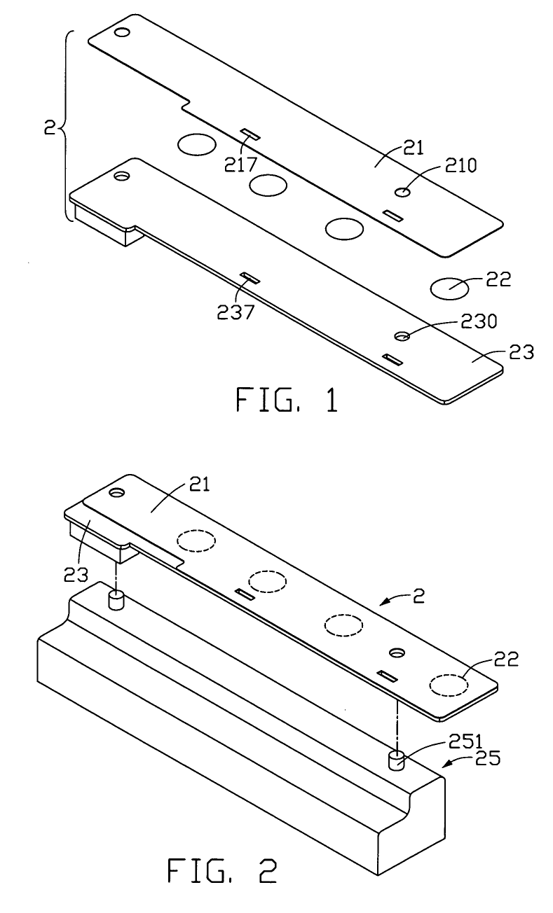

As shown in FIG. 2, when the button module 2 is pre-assembled, the first and second positioning holes 210, 230 are aligned so that they can receive corresponding portions of a positioning tool 25 that the button module 2 is removably mounted on. In particular, in the illustrated embodiment, the positioning tool 25 includes at a pair of positioning posts 251. The positioning posts 251 engage in the first and second positioning holes 210, 230, in order to align the first and second locking holes 217, 237. The touch pad 21 may be adhered to the printed circuit board 23, such that the touch pad 21 covers the printed circuit board 23 and the elastic contact pads 22. Then the positioning tool 25 can be removed.

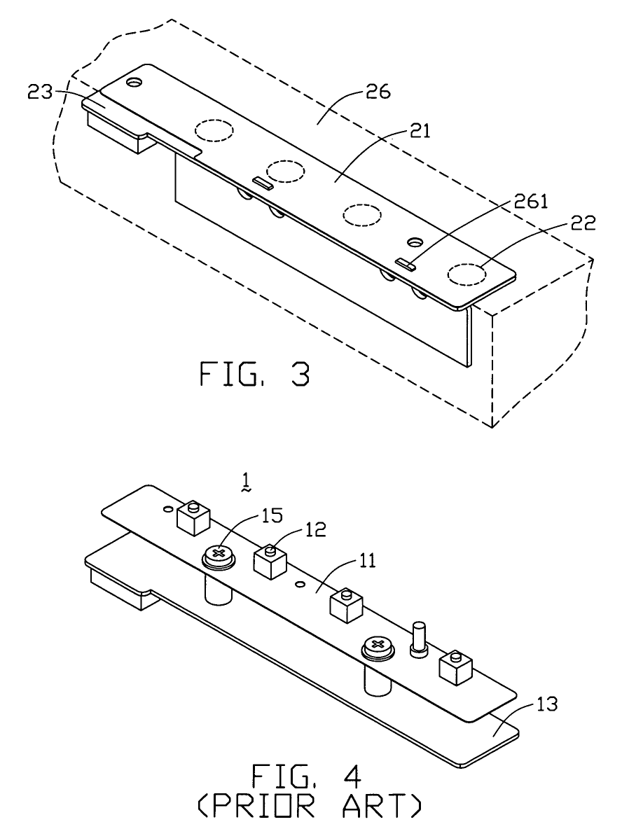

As shown in FIG. 3, an exemplary display module 26 includes a pair of protrusions 261. The protrusions 261 may for example be arranged on a frame of the display module 26. A shape of the protrusions 261 matches a shape of the first and second locking holes 217, 237. In the illustrated embodiment, the protrusions 261 are generally block-shaped. The button module 2 is attached on the display module 26 such that the protrusions 261 engage in the first and second locking holes 217, 237. Thereby, the button module 2 is fastened on the display module 26. In the illustrated embodiment, the protrusions 261 project out above the touch pad 21 of the button module 2. In another embodiment, the protrusions 261 can be flush with the touch pad 21.

The protrusions 261 and the first and second locking holes 217, 237 may alternatively have shapes other than the shapes illustrated. For example, the protrusions 261 and the first and second locking holes 217, 237 may be cylindrical, polygonal, or strip-shaped.

In operation, pressing of any one of the elastic contact pads 22 generates a corresponding signal in the printed circuit board 23. The printed circuit board 23 may accordingly drive function menus associated with the display module 26. For example, the printed circuit board 23 may drive an OSD, in order to adjust the characteristics of a display associated with the display module 26.

The configuration of the protrusions 261 and the first and second locking holes 217, 237 enables the button module 2 to be fastened to the display module 26 without the need for extra fasteners such as screws. Moreover, an overall thickness (or height) of the display module 26 may be reduced.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A button module, comprising:
a printed circuit board;
a touch pad corresponding to the printed circuit board; and
at least one elastic contact pad sandwiched between the touch pad and the printed circuit board.

2. The button module as claimed in claim 1, wherein the touch pad comprises a first locking hole, and the printed circuit board comprises a second locking hole.

3. The button module as claimed in claim 2, wherein the first and the second locking holes correspond to each other in location.

4. The button module as claimed in claim 1, wherein the at least one elastic contact pad is hemispherical or partially hemispherical.

5. The button module as claimed in claim 1, wherein the at least one elastic contact pad is generally ellipsoidal.

6. The button module as claimed in claim 1, wherein the touch pad is adhered to the printed circuit board.

7. The button module as claimed in claim 1, wherein the touch pad comprises a first positioning hole.

8. The button module as claimed in claim 7, wherein the printed circuit board comprises a second positioning hole.

9. The button module as claimed in claim 8, wherein the first and second positioning holes correspond to each other in location.

10. The button module as claimed in claim 1, wherein a material of the elastic contact pads is flexible.

11. An electronic device, comprising:
a frame comprising at least one protrusion; and
a button module, comprising:
a touch pad comprising at least one first locking hole;
a printed circuit board comprising at least one second locking hole; and
at least one elastic contact pad sandwiched between the touch pad and the printed circuit board;
wherein the at least one first and second locking holes corresponding to each other in location, and the at least one protrusion is engaged in the at least one first and second locking holes.

12. The electronic device as claimed in claim 11, wherein the at least one elastic contact pad is hemispherical or partially hemispherical.

13. The electronic device as claimed in claim 11, wherein the at least one elastic contact pad is generally ellipsoidal.

14. The electronic device as claimed in claim 11, wherein the touch pad is adhered to the printed circuit board.

15. The electronic device as claimed in claim 11, wherein the touch pad comprises a first positioning hole.

16. The electronic device as claimed in claim 15, wherein the printed circuit board comprises a second positioning hole.

17. The electronic device as claimed in claim 16, wherein the first and second positioning holes correspond to each other in location.

18. The electronic device as claimed in claim 11, wherein the at least one protrusion is generally block-shaped, cylindrical, polygonal, or strip-shaped.

19. The electronic device as claimed in claim 11, wherein a material of the at least one elastic contact pad is flexible.
